(19) United States
(12) Patent Application Publication
(10) Pub. No.: US 2011/0291983 A1
(43) Pub. Date: Dec. 1, 2011

(54) TOUCH DISPLAY DEVICE

(75) Inventor: Po-Jen Yao, Taipei County (TW)

(73) Assignee: CHUNGHWA PICTURE TUBES, LTD., Taoyuan (TW)

(21) Appl. No.: 12/832,986

(22) Filed: Jul. 8, 2010

(30) Foreign Application Priority Data
May 31, 2010 (TW) 99117436

(51) Int. Cl. G06F 3/041; G06F 3/045

(52) U.S. Cl. 345/174; 345/175

(57) ABSTRACT

A touch display device includes a display module, a touch module, and an elastic optical film. The touch module is disposed above the display module. The elastic optical film is not adhesive and is located between the touch module and the display module. The elastic optical film is elastically deformed to fill a gap between the touch module and the display module when the touch module is assembled and located above the display module.

### CROSS-REFERENCE TO RELATED APPLICATION

This application claims the priority benefit of Taiwan application serial no. 99117436, filed on May 31, 2010. The entirety of the above-mentioned patent application is hereby incorporated by reference herein and made a part of specification.

### BACKGROUND OF THE INVENTION

1. Field of the Invention

The invention relates to a display device. More particularly, the invention relates to a touch display device.

2. Description of Related Art

A touch panel is a popular man-machine interface. The touch panel can be assembled to various flat displays in order to display frames on the flat displays and input operation information.

In general, a touch display device mainly includes a display panel and a touch panel. In a conventional touch display device, the touch panel and the display panel are adhered together by double-sided adhesive tape. Since the double-sided adhesive tape is merely disposed around the display panel and the touch panel, an air layer exists between the touch panel and the display panel. Light in the surroundings is reflected in the air layer, such that contrast and visibility of the display panel are reduced.

To overcome the above shortcomings, in another conventional touch display device, the display panel and the touch panel are adhered together by optical adhesive. The optical adhesive is entirely coated between the display panel and the touch panel, and therefore reflection at an interface between the two panels does not occur in the touch display device, and favorable display effects can be achieved. Nonetheless, long-term use of the optical adhesive results in poor reliability. Moreover, air bubbles may be generated in the optical adhesive during assembly, thus leading to abnormal light scattering. Besides, the optical adhesive increases the entire thickness and deteriorates reworkability when the display panel and the touch panel are not well adhered. In particular, given that the touch panel is damaged but not the display panel, it is rather difficult to exchange the touch panel.

### SUMMARY OF THE INVENTION

The invention is directed to a touch display device characterized by favorable reworkability. In the touch display device, elements can be easily assembled.

In the invention, a touch display device including a frame, a display module, a touch module, and an elastic optical film is provided. The frame has a vertical sidewall portion and a horizontal extension portion that define containing space. The display module is disposed in the containing space, and a side of the display module leans against the vertical sidewall portion of the frame. The touch module is disposed above the display module. The elastic optical film is disposed in the containing space and located between the touch module and the display module. The non-adhesive elastic optical film is elastically deformed when the touch module is assembled and located above the display module.

According to an embodiment of the invention, the horizontal extension portion of the frame is disposed on the touch module.

According to an embodiment of the invention, the horizontal extension portion of the frame holds at least two of the sides of the touch module.

According to an embodiment of the invention, the touch display device further includes an adhesive layer disposed between the touch module and the horizontal extension portion of the frame.

According to an embodiment of the invention, a material of the elastic optical film includes polymethylmethacrylate (PMMA, a.k.a. “acrylic”), polycarbonate (PC), polystyrene, polyethylene (PE), polyvinyl chloride (PVC), polyester (PET), o-phenylphenol (OPP) plastic, perfluorinated plastic, or epoxy plastic.

According to an embodiment of the invention, a relative refractive index of the elastic optical film is within a range of 1±30%.

According to an embodiment of the invention, a transmission index of the elastic optical film is greater than or equal to 90%.

According to an embodiment of the invention, the display module includes a backlight module and a display panel that is located between the backlight module and the elastic optical film.

According to an embodiment of the invention, the display module includes a flexible display.

According to an embodiment of the invention, the touch module includes a capacitive touch panel, a resistive touch panel, a sonic touch panel, an infrared touch panel, an optical touch panel, or a flexible touch panel.

Based on the above, in the touch display device of the invention, the non-adhesive elastic optical film is disposed between the display module and the touch module, and the two modules are fixed by the frame. Hence, when the touch module or the display module is damaged, or when the elastic optical film is not accurately disposed, the frame and the touch module disposed thereon can be directly removed, the touch module or the display module can be replaced, or the location of the elastic optical film can be adjusted, so as to finish the reworking process. That is to say, the touch display device of the invention facilitates processes of assembly and reworking, improves positioning accuracy of assembly, and better protects the touch module or the display module from being damaged.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a touch display device according to an embodiment of the invention.

FIG. 2 is a schematic diagram illustrating a touch display device according to another embodiment of the invention.

FIG. 3 is a schematic diagram illustrating a touch display device according to still another embodiment of the invention.

### DESCRIPTION OF EMBODIMENTS

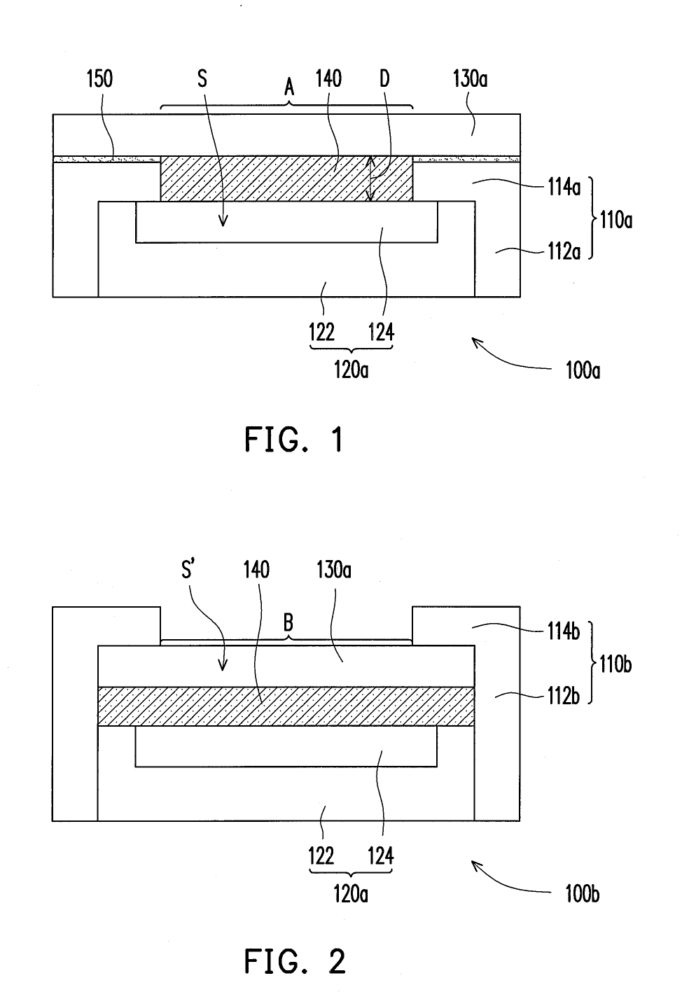

FIG. 1 is a schematic diagram illustrating a touch display device according to an embodiment of the invention. As indicated in FIG. 1, a touch display device 100a of the embodiment includes a frame 110a, a display module 120a, a touch module 130a, and an elastic optical film 140.

To be more specific, the frame 110a has a vertical sidewall portion 112a and a horizontal extension portion 114a that define containing space S. The vertical sidewall portion 112a and the horizontal extension portion 114a are connected, and the horizontal extension portion 114a extends from the vertical sidewall portion 112a and along a direction which is perpendicular to an extending direction of the vertical sidewall portion 112a. Space located within the vertical sidewall portion 112a and the horizontal extension portion 114a of the frame 110a is defined as the containing space S. In this embodiment, a material of the frame 110a is light and with sufficient mechanical strength, e.g. metal aluminum or iron. In other embodiments, the material of the frame 110a can also be plastic.

The display module 120a is disposed in the containing space S defined by the vertical sidewall portion 112a and the horizontal extension portion 114a of the frame 110a. A side of the display module 120a leans against the vertical sidewall portion 112a of the frame 110a, and the horizontal extension portion 114a surrounds regions other than a display region A of the display module 120a. In this embodiment, the display module 120a includes a backlight module 122 and a display panel 124, and the backlight module 122 is located below the display panel 124. The backlight module 122, for example, is a side incident backlight module or a direct type backlight module, and the display panel 124, for example, is a liquid crystal display panel or any other appropriate display panel, which should not be construed as a limitation to this invention.

The touch module 130a is disposed above the display module 120a. Specifically, in this embodiment, the horizontal extension portion 114a of the frame 110a holds at least two of the sides of the touch module 130a, and space between the touch module 130a and the display module 120a has a height D. The touch module 130a, for instance, is a capacitive touch panel, a resistive touch panel, a sonic touch panel, an infrared touch panel, or an optical touch panel, which should not be construed as a limitation to this invention.

The elastic optical film 140 is disposed in the containing space S defined by the vertical sidewall portion 112a and the horizontal extension portion 114a of the frame 110a, and the elastic optical film 140 is located between the touch module 130a and the display panel 124 of the display module 120a. In particular, the elastic optical film 140 of this embodiment is non-adhesive and highly transparent. Before the touch module 130a is assembled to the frame 110a, a thickness of the elastic optical film 140 is substantially greater than or equal to the height D. However, the elastic optical film 140 is elastically deformed (e.g. compressed) when the touch module 130a is assembled to the frame 110a and located above the display module 120a. As such, the entire thickness of the elastic optical film 140 is substantially equal to the height D, and the elastic optical film 140 closely adhered between the touch module 130a and the display module 120a.

According to this embodiment, a material of the elastic optical film 140 includes polymethylmethacrylate (PMMA, a.k.a. “acrylic”), polycarbonate (PC), polystyrene, polyethylene (PE), polyvinyl chloride (PVC), polyester (PET), o-phenylphenol (OPP) plastic, perfluorinated plastic, or epoxy plastic. A relative refractive index of the elastic optical film 140 is within a range of 1±30%, and a transmission index of the elastic optical film 140 is greater than or equal to 90%. Since the refractive index of the elastic optical film 140 is similar to the refractive index of glass, optical loss between the touch module 130a and the display module 120a can be reduced.

In this embodiment, the touch display device 100a further includes an adhesive layer 150 disposed between the touch module 130a and the horizontal extension portion 114a of the frame 110a, such that the touch module 130a is fixed onto the frame 110a.

The non-adhesive elastic optical film 140 in the touch display device 100a of this embodiment is disposed between the display module 120a and the touch module 130a, and the two modules are fixed by the frame 110a and the adhesive layer 150. Therefore, the optical loss between the touch module 130a and the display module 120a can be reduced by disposing the elastic optical film 140 according to this embodiment. In the meantime, when the touch module 120a or the display module 130a is damaged and needs to be replaced, or when the elastic optical film 140 is not accurately disposed during assembly, the frame 110a and the touch module 130a disposed thereon can be directly removed, such that the elastic optical film 140 can be easily taken out and rearranged. In an alternative, the display module 120a or the touch module 130a can be replaced. Thereby, in the touch display device 100a of this embodiment, positioning accuracy of assembly can be improved, and the touch module 130a or the display module 120a can be better protected from being damaged. As a result, the design of the touch display device 100a in this invention can resolve the conventional issues of abnormal light scattering, reduced reworkability, difficulty in replacing the touch panel or the display panel, and poor reliability caused by sticky optical adhesive. Namely, the touch display device 100a of the invention facilitates processes of assembly and reworking.

Note that an opening (not shown) can be formed in the frame 110a according to this embodiment in order to allow the elastic optical film 140 to be completely adhered between the touch module 130a and the display module 120a. During assembly, gas between the touch module 130a and the display module 120a can be discharged through the opening. Alternatively, a gas extracting apparatus (not shown) can extract the gas between the touch module 130a and the display module 120a through the opening, such that the elastic optical film 140 is spontaneously adhered to the touch module 130a and the display module 120a. Users can select or design appropriate components at their discretion to accomplish the technical effects, and the invention poses no limitation to the way to adhere the elastic optical film 140 to the touch module 130a and the display module 120a.

FIG. 2 is a schematic diagram illustrating a touch display device according to another embodiment of the invention. With reference to FIG. 1 and FIG. 2, in this embodiment, the touch display device 100b depicted in FIG. 2 is similar to the touch display device 100a depicted in FIG. 1, and therefore some elements are marked by the same reference numbers. The difference between the touch display devices 100b and 100a lies in that the horizontal extension portion 114b of the frame 110b as depicted in FIG. 2 is disposed on the touch module 130a. In particular, the touch module 130a of this embodiment is disposed in the containing space S′ defined by the vertical sidewall portion 112b and the horizontal extension portion 114b of the frame 110b. Sides of the display module 120a, the elastic optical film 140, and the touch module 130a lean against the vertical sidewall portion 112b of the frame 110b, and the horizontal extension portion 114b surrounds regions other than a display region B of the touch module 130a. Besides, the horizontal extension portion 114b of the frame 110b and the touch module 130a can be fixed together by an adhesive layer (not shown) or by mechanical locking or wedging, which is not limited in this invention.

The frame 110b is used in the touch display device 100b of this embodiment to fix the display module 120a and the touch module 130a. Besides, the non-adhesive elastic optical film 140 is employed to reduce optical loss between the touch module 130a and the display module 120a. Hence, in comparison with the conventional double-sided adhesive tape or the conventional optical adhesive that fixes the display panel and the touch panel, the elastic optical film 140 of this embodiment facilitates processes of assembly and reworking of the touch display device 100b, improves positioning accuracy of assembly, and better protects the touch module 130a or the display module 120a from being damaged.

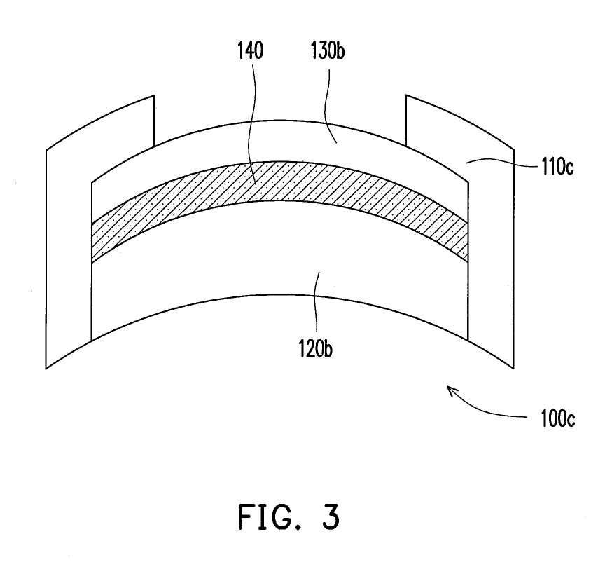

FIG. 3 is a schematic diagram illustrating a touch display device according to another embodiment of the invention. With reference to FIG. 3 and FIG. 2, in this embodiment, the touch display device 100c depicted in FIG. 3 is similar to the touch display device 100b depicted in FIG. 2, and therefore some elements are marked by the same reference numbers. The difference between the touch display devices 100c and 100b lies in that the display module 120b in the touch display device 100c depicted in FIG. 3 is, for example, a flexible display, and the touch module 130b is, for example, a flexible touch panel. Since the elastic optical film 140 of this embodiment is non-adhesive and elastic, the touch display device 100c has favorable flexibility when the display module 120b, the elastic optical film 140, and the touch module 130b are assembled to form the touch display device 100c.

To sum up, in the touch display device of the invention, the non-adhesive elastic optical film is disposed between the display module and the touch module, and the two modules are fixed together by the frame. Hence, when the touch module or the display module is damaged, or when the elastic optical film is not accurately disposed, the frame and the touch module disposed thereon can be directly removed, the touch module or the display module can be replaced, or the location of the elastic optical film can be adjusted, so as to finish the reworking process. That is to say, the touch display device of the invention facilitates the processes of assembly and reworking, improves positioning accuracy of assembly, and better protects the touch module or the display module from being damaged.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display device comprising:
a display module;
a touch module disposed above the display module; and
an elastic optical film located between the touch module and the display module, wherein the elastic optical film is not adhesive and elastically deformed when the touch module is assembled and located above the display module.

2. The touch display device as claimed in claim 1 further comprising a frame having a vertical sidewall portion and a horizontal extension portion defining a containing space, the display module being disposed in the containing space, a side of the display module leaning against the vertical sidewall portion of the frame.

3. The touch display device as claimed in claim 2, wherein the horizontal extension portion of the frame is disposed on the touch module.

4. The touch display device as claimed in claim 2, wherein the horizontal extension portion of the frame holds at least two of the sides of the touch module.

5. The touch display device as claimed in claim 2 further comprising an adhesive layer disposed between the touch module and the horizontal extension portion of the frame.

6. The touch display device as claimed in claim 1, wherein a material of the elastic optical film comprises polymethylmethacrylate, polycarbonate, polystyrene, polyethylene, polyvinyl chloride, polyester, o-phenylphenol plastic, perfluorinated plastic, or epoxy plastic.

7. The touch display device as claimed in claim 1, wherein a relative refractive index of the elastic optical film is within a range of 1±30%.

8. The touch display device as claimed in claim 1, wherein the display module comprises a backlight module and a display panel, and the display panel is located between the backlight module and the elastic optical film.

9. The touch display device as claimed in claim 1, wherein the display module comprises a flexible display.

10. The touch display device as claimed in claim 1, wherein the touch module comprises a capacitive touch panel, a resistive touch panel, a sonic touch panel, an infrared touch panel, an optical touch panel, or a flexible touch panel.
